(19) United States
(12) Patent Application Publication
(10) Pub. No.: US 2007/0017867 A1
(43) Pub. Date: Jan. 25, 2007

(54) Submerged attached growth bioreactor

(76) Inventors: Philip B. Pedros, Wakefield, MA (US); Keith Dobie, Humarock, MA (US)

Correspondence Address: LAW OFFICES OF JOHN P. MCGONAGLE, 800 HINGHAM STREET - 2N, ROCKLAND, MA, 02370, US

(21) Appl. No.: 11/474,788

(22) Filed: Jun. 26, 2006

Related U.S. Application Data
(60) Provisional application No. 60/700,820, filed on Jul. 21, 2005.

(51) Int. Cl. C02F 3/00

(52) U.S. Cl. 210/615

(57) ABSTRACT

a wastewater treatment system having a submerged attached growth bioreactor connected to an equalization tank and a clear well. The bioreactor has a deep-bed sand filter. the wastewater flow through the filter is in two directions, i.e., down flow (forward flow) and up flow (reverse flow). The hydrostatic pressure created by the differential liquid levels within the tanks creates a forward flow from the equalization tank, into the bioreactor and out into the clear well. Reverse flow is accomplished by pumping from the clear well back up through the bioreactor. The reverse flow fills the headspace within the bioreactor, stops, and then begins to flow forward again. The flow through the bioreactor alternates between down flow and up flow. In an alternative embodiment, process air required for the oxidation of organics and nitrification is accomplished by aerating the clear well. The oxygen rich water is pumped into the filter from the clear well during the reverse flow. The process air is supplied to the clear well via air diffusers.

### CROSS-REFERENCE TO RELATED APPLICATIONS

Applicants claim the priority benefits of U.S. Provisional Patent Application Number 60/700,820, filed Jul. 21, 2005.

### BACKGROUND OF THE INVENTION

This invention relates to waste treatment systems, and in particular, to a single-unit, single-zone bioreactor for the combined removal of organics and nitrogen while operating in both a down flow and up flow mode with intermittent aeration to the filter.

The presence of nitrogen compounds in lakes, rivers and other water bodies promote unwanted growth of algae and other aquatic plants that consume dissolved oxygen. Consequently, there is a need to reduce nitrogen compounds in wastewater prior to discharge of the wastewater.

A number of processes and apparatus have been proposed for the nitrification and denitrification of wastewater containing nitrogen compounds. Generally, in such systems, wastewater containing nitrogen compounds such as ammonia and organic nitrogen compounds is passed through a reactor vessel under aerobic conditions to oxidize the nitrogen compounds to nitrates and then passed through another reactor vessel under anoxic conditions to denitrify the nitrified wastewater. The nitrogen gas formed during denitrification is released to the atmosphere while the treated wastewater, with a reduced level of nitrogen compounds, is returned to the ground or receiving stream. Typically, such systems also utilize a settling tank or clarification zone after the wastewater has been biologically treated.

Accordingly, there is a need for a process and apparatus that reduces nitrogen compounds from wastewater to an environmentally acceptable level and is relatively simple to operate and maintain. One such process is based on a submerged attached growth bioreactor.

The two primary advantages of submerged attached growth bioreactors are the small volume requirement and the elimination of downstream clarification, if the media used has a high specific surface area. Such media allows for a high biomass concentration to be maintained within the reactor and, therefore, a short hydraulic time (HRT). A short HRT results in a relatively smaller volume bioreactor needed to treat a given waste strength. In addition, the media also provides physical filtration. Therefore, the need for solids separation after the biological treatment process is avoided. Different configurations of submerged attached growth bioreactors have been implemented in both full scale plants and pilots. Studies have yielded important operational information regarding the use of submerged attached growth bioreactors for the removal of carbonaceous matter and nitrogen. A pilot study of a submerged attached growth bioreactor installed in series and downstream of a denitrification unit demonstrated that a recirculation of 300% of the inflow, from the filter back to the denitrification unit, removed organics and nitrogen to the required levels. Combined removal of organics and nitrogen has been demonstrated in a single submerged attached growth bioreactor with a separate anoxic zone created within the reactor. However, these systems provide aeration to the reactor and operate in either a down flow or an up flow mode. Dissolved oxygen (DO) is required for nitrification but inhibits denitrification. Therefore, nitrification at the lowest DO possible is preferred so that excess DO is not introduced into the denitrification process. The use of the present invention's single unit, single zone, submerged attached growth bioreactor for achieving the combined removal of organics and nitrogen operating in both a down flow and an up flow mode, with intermittent aeration to the filter, is new.

### SUMMARY OF THE INVENTION

In a first embodiment of the invention, the present invention is comprised of one submerged attached growth bioreactor connected to an equalization tank and a clear well. See FIG. 1. The bioreactor is a deep-bed sand filter consisting of an underdrain, a support gravel bed and filter media. The equalization tank receives the wastewater and allows for primary settling of the solids in the wastewater. The clear well tank stores enough of the treated effluent to allow for return flows and periodic backwashes. Excess liquid is discharged continuously from the clear well. Two significant features of this first process are novel. First, the wastewater flow through the filter is in two directions, i.e., down flow (forward flow) and up flow (reverse flow). The hydrostatic pressure created by the differential liquid levels within the tanks is the driving force of the forward flow from the equalization tank, into the bioreactor and out into the clear well. Reverse flow is accomplished by pumping from the clear well back up through the bioreactor. The reverse flow fills the headspace within the bioreactor, stops, and then begins to flow forward again. The flow through the bioreactor alternates between down flow and up flow. Second, the bioreactor is operated as a continuous flow process. Although some of the flow cycles through the filter, treated effluent is continuously discharged from the clear well. The intermittent aeration of the bioreactor provides sufficient air for the removal of organics and nitrification, an minimizes the amount of excess so that denitrification occurs within the same reactor.

In a second embodiment of the invention as shown in FIGS. 2 and 3, process air required for the oxidation or organics and nitrification is accomplished by aerating the clear well, not the bioreactor filter. The oxygen rich water is pumped into the filter during a return flow thereby providing the biomass with the required oxygen. This reduces the penetration of DO into the biofim and enhances denitrification process. The process air is supplied to the clear well via diffusers. The only air supplied to the bioreactor is for backwash. Backwash is required to remove excess biomass from the bioreactor. Control of the air to either the reactor or the clear well is achieved by valves in the air lines.

These together with other objects of the invention, along with various features of novelty which characterize the invention, are pointed out with particularity in this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a block diagram of a submerged attached growth bioreactor system constructed according to the invention.

FIG. 2 is a block diagram of a submerged attached growth bioreactor system constructed according to the invention and having means for clear well aeration.

FIG. 3 is a top view of the aerated clear well.

FIG. 4 is a block diagram of a submerged attached growth bioreactor system followed by a microfiltration unit.

### DETAILED DESCRIPTION OF INVENTION

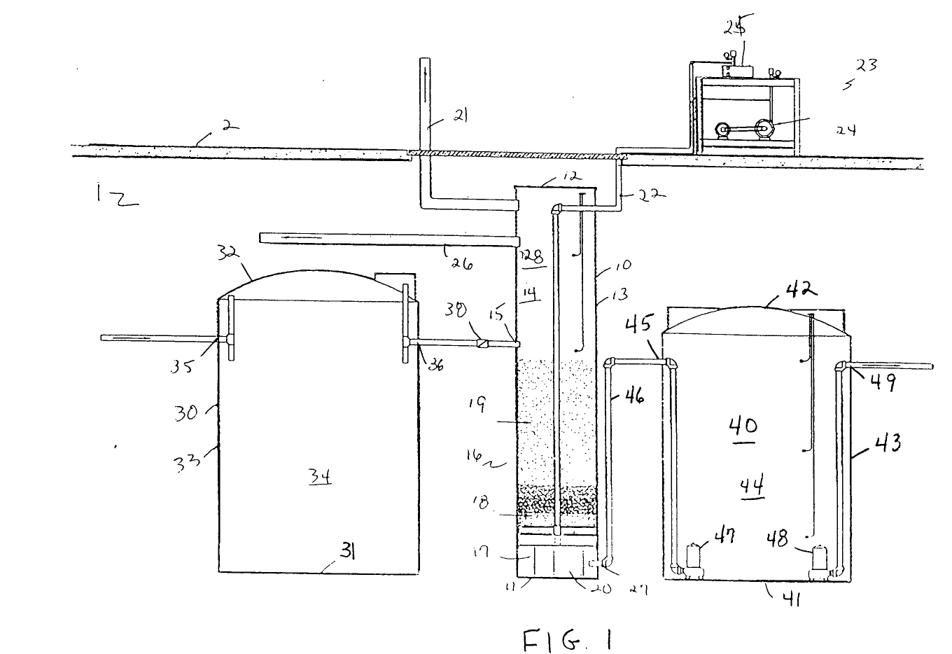

Referring to the drawings in detail wherein like elements are indicated by like numerals, there is shown two embodiments of a wastewater treatment system 1 constructed according to the principles of the present invention. A first embodiment of the invention is shown in FIG. 1 which illustrates a submerged attached growth bioreactor 10, connected to an equalization tank 30 and a clear well 40.

The equalization tank 30 is comprised of a bottom 31, a top 32, and a side wall 33 interconnecting the bottom 31 and top 32, said bottom, top and side wall defining a hollow, equalization tank interior 34. The equalization tank 30 includes an influent inlet 35 for receiving wastewater thereby providing a path for the wastewater from a source external to the equalization tank and into the equalization tank interior 34. The equalization tank 30 also includes an outlet 36 which is in communication with a first inlet 15 of the bioreactor 10. A check valve 38 is inserted into the outlet line 36 which prevents reverse flow from the bioreactor 10 to the equalization tank 30. The equalization tank 30 provides an equalization zone, and an anoxic pretreatment/sludge storage zone. The equalization tank 30 equalizes and stores forward flow prior to treatment in the bioreactor 10. The equalization tank 10 also settles inert and biological solids that are included in the wastewater to be treated as well as, in some invention embodiments, backwash solids that are included in the reverse flow from the bioreactor 10. The equalization tank 10 stores and biologically digests settled sludge. Digestion of biological solids in the equalization tank 30 creates an additional source of soluble BOD (biochemical oxygen demand) which is used for denitrification.

The bioreactor 10 is comprised of a bottom 11, a top 12, and a side wall 13 interconnecting the bottom 11 and top 12, said bottom, top and side wall defining a hollow, bioreactor interior 14. The bioreactor 10 includes a first inlet 15 which is in communication with the equalization tank outlet 36. The bioreactor interior 14 has a deep-bed sand filter 16 consisting of an underdrain 17 adjacent the bioreactor bottom 11, a support gravel bed 18, and filter media 19. The gravel bed 18 is placed on the underdrain 17 and has a depth of approximately 1.5 feet. In this embodiment of the invention, the gravel bed 18 has four different sizes of gravel in five layers, placed in order of descending size, i.e., the largest at the bottom adjacent the underdrain 17. Other invention embodiments may have different numbers of gravel sizes and different numbers of layers. The purpose of the gravel bed 18 is to keep the smaller filter media 19 from penetrating down into a plenum 20 below the underdrain 17 adjacent the bioreactor bottom 11. The plenum 20 interconnects to an adjacent bioreactor outlet 27 in the bioreactor side wall 13. The filter media 19 above the gravel 18 is comprised of a bed of coarse round, silica sand acting as filtration media 19. The sand functions as a filter and provides the surface area on which an attached growth biomass can be maintained. The sand media nominally has a 2.5-3.5 millimeter (mm) nominal diameter producing a media porosity of approximately 40%. Other invention embodiments may have different diameters. The resulting media specific surface area of approximately 650 m²/cubic meter provides a large surface area resulting in a high concentration of biomass in a relatively small volume and provides physical filtration.

The bioreactor 10 has a vent pipe 21 outletting above the ground surface 2 to the atmosphere. An air pipe 22 is inserted through the bioreactor top 12, through the bioreactor interior 14, through the filter media 19 and gravel bed 18. The air pipe 22 is interconnected to the underdrain on the ground surface 2. The air pipe 22 provides process air and backwash air to the sand filter 16. The aeration system 23 includes a backwash blower 24 and process blower 25. The bioreactor 10 further includes an outlet backwash line 26 inserted through the bioreactor side wall 13 above the filter media 19. The backwash line 26 is interconnected to the system headworks which may be comprised of the equalization tank 30 or a separate tank (not shown) feeding into the equalization tank 30.

The clear well 40 is comprised of a bottom 41, a top 42, and a side wall 43 interconnecting the bottom 41 and top 42, said bottom, top and side wall defining a hollow, clear well interior 44. The clear well 40 includes a first inlet 45 with an inlet pipe 46 connected to the bioreactor outlet 27. The clear well interior 44 may contain two pumps, depending on size. In this embodiment, a two pump arrangement is illustrated. The clear well interior 44 contains a first pump system 47 on the clear well bottom 41, said first pump 47 being connected to said clear well first inlet 45 and being adapted to provide reverse flow from the clear well interior 44 back through the bioreactor interior 14. The clear well interior 44 also contains a second pump system 48 on the clear well bottom 41, said second pump being interconnected to a clear well discharge outlet 49, said second pump 48 adapted to discharge the contents of said clear well interior 44 out through said discharge outlet 49.

The equalization tank outlet 36 is vertically positioned lower than the equalization tank inlet 35, thereby creating a gravity flow through and out of the equalization tank interior 34. There is also a difference in vertical elevation between the equalization tank outlet 36 and the clear well first inlet 45, thereby creating a driving force for gravity flow of the wastewater from the equalization tank 30 through the bioreactor 10 to the clear well 40.

The equalization tank 30 receives the wastewater and provides primary settling of solids in the wastewater. The clear well 40 stores enough of the treated effluent to provide return flows and periodic backwashes. Excess liquid is continuously discharged from the clear well interior 44. Two significant features of this invention embodiment are novel. First, the wastewater flow through the bioreactor filter 16 is in two directions, i.e., down-flow (forward flow) and up-flow (reverse flow). The hydrostatic pressure created by the differential liquid levels within the tanks 30, 10, 40 is the driving force of the forward flow through the system, through the clear well inlet pipe 46 into the clear well first inlet through the clear well idle first pump 47. The reverse flow is accomplished by the first pump 47 pumping liquid from the clear well interior 44 back up through the clear well first inlet 45, clear well inlet pipe 46, into the bioreactor interior 14, through the gravel bed 18 and sand filter 16. The reverse flow fills the bioreactor head space 28 above the filter media 19 and then begins to flow forward again. Therefore, flow through the bioreactor 10 alternates between down-flow and up-flow. Second, the system is operated as a continuous flow process. Although some of the flow cycles through the bioreactor filter 16, treated effluent from the clear well 40 is discharged continuously.

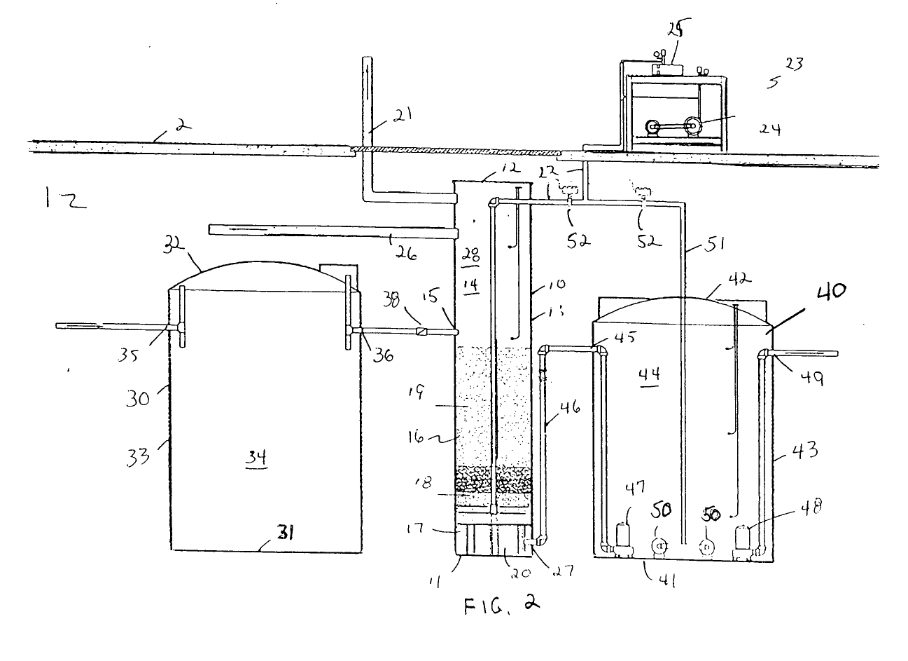

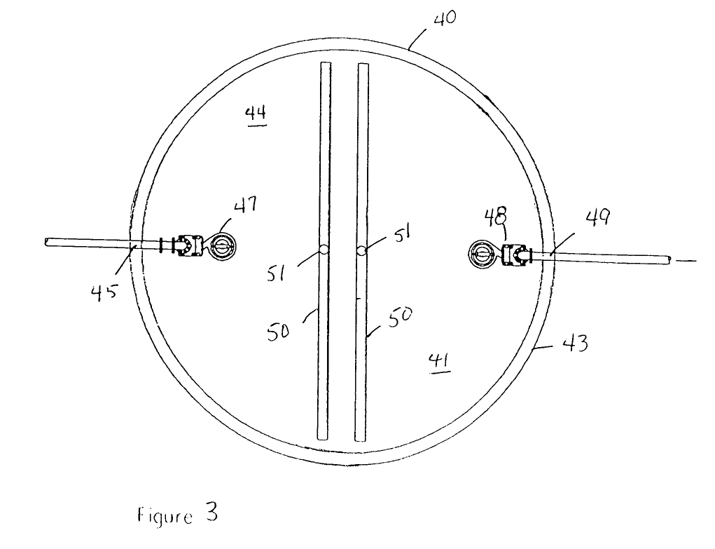

Referring to FIGS. 2 and 3, there is shown a second embodiment of the invention. In this embodiment of the invention means are provided to aerate the clear well 40. Process air for the oxidation of organics and nitrification in the bioreactor 10 is provided by aerating the clear well interior 44 and not the bioreactor filter 16 as shown in FIG. 1. The oxygen-rich water in the clear well 40 is pumped through the bioreactor filter 16 during a reverse flow cycle providing the bioreactor biomass with oxygen. The process air is supplied to the clear well interior 44 via aeration diffusers 50 located in the clear well interior 44 adjacent the clear well bottom 41. The air is supplied by the aeration system 23. A process air 51 is brought off the air pipe 22 into the clear well and connected to the diffusers 50. Electrically activated valves 52 control air flow through the air pipe 22 and process air pipe 51. There is no direct aeration of the bioreactor as is usually found in prior filters designed for the removal of organics and nitrification. The only air directly supplied to the bioreactor 10 is for backwash. A backwash is required to remove excess biomass from the bioreactor 10. The second embodiment of the invention provides increased denitrification over the first embodiment of the invention.

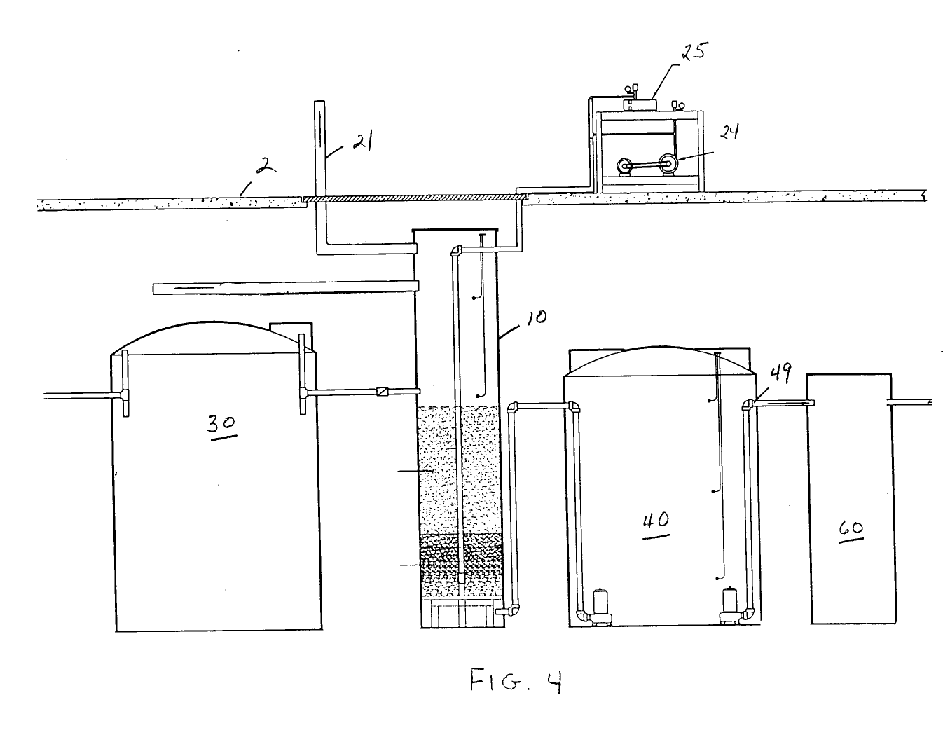

The integration of a submerged attached growth bioreactor based wastewater treatment system with a membrane microfiltration unit is a process designed to meet stringent effluent nutrient limits and wastewater reuse requirements. See FIG. 4. The use of a submerged attached growth bioreactor for biological nutrient removal provides a system with a small foot print due to its ability to operate with high concentrations of biomass. If the media within the filter is fine enough, the media functions as a filter, reducing suspended solids and eliminating the need for downstream clarification. In the submerged attached growth bioreactor, itself, media specific surface area of 650 m²/cubic meter results in a high concentration of biomass within the reactor, which means that the hydraulic retention time is short. Therefore, the submerged attached growth bioreactor requires a significantly smaller volume to treat a given waste stream than would be required with either a different fixed film reactor or a membrane reactor. A submerged attached growth bioreactor of this type, when placed upstream of a microfiltration unit will meet stringent effluent limits. The submerged attached growth bioreactor produces high quality feed water to the microfiltration unit, which will allow higher flux rates through the membrane unit and, therefore, a reduced total membrane area requirement.

The submerged attached growth bioreactor process achieves the biological separation and solids separation of the biomass. The submerged attached growth bioreactor is constructed from a deep-bed sand filter and intermittently aerated to achieve combined biological oxidation of the carbonaceous organics and complete nitrogen removal. The output of the submerged attached growth bioreactor 10 is passed to a clear well 40 as described above. The membrane microfiltration unit 60 is attached to the clear well discharge outlet 49 and removes only suspended materials, typically down to approximately 0.05 microns in size. There are several advantages with the combined submerged attached growth bioreactor and membrane microfiltration process. The biomass concentration within some submerged attached growth bioreactors can range from 7,000-15,000 mg-VS/l of media, which reduces the area requirement to treat a given wastewater. Depending on the media specific surface area, the need for downstream clarification may be eliminated. Membrane microfiltration is not part of the biological process. Therefore, the air scour of the membranes does not adversely affect the denitrification process. The consequent is that a low DO, just high enough to achieve nitrification, can be maintained in the submerged attached growth bioreactor. This facilitates denitrification and reduces the cost of any supplemental carbon source that may be required.

It is understood that the above-described embodiment is merely illustrative of the application. Other embodiments may be readily devised by those skilled in the art which will embody the principles of the invention and fall within the spirit and scope thereof.

We claim:

1. A wastewater treatment system, comprising:
a submerged attached growth bioreactor having a bottom, a top, and a side wall interconnecting the bottom and top, said bottom, top and side wall defining a hollow, bioreactor interior, said bioreactor having a first inlet which is in communication with an equalization tank outlet, said bioreactor interior having a deep-bed sand filter with an underdrain adjacent the bioreactor bottom, a support gravel bed, filter media, and a plenum below the underdrain adjacent the bioreactor bottom, said plenum interconnecting to an adjacent bioreactor outlet in the bioreactor side wall;
an equalization tank connected to said bioreactor, said equalization tank having a bottom, a top, and a side wall interconnecting the bottom and top, said bottom, top and side wall defining a hollow, equalization tank interior, said equalization tank having an influent inlet for receiving wastewater from a source external to the equalization tank and into the equalization tank interior; and
a clear well attached to said bioreactor, said clear well having a bottom, a top, and a side wall interconnecting the bottom and top, said bottom, top and side wall defining a hollow, clear well interior, said clear well having a first inlet with an inlet pipe connected to the bioreactor outlet, said clear well interior having a first pump system on the clear well bottom, said first pump system being connected to said clear well first inlet and being adapted to provide reverse flow from the clear well interior back through the bioreactor interior, said clear well interior having a second pump system on the clear well bottom, said second pump system being interconnected to a clear well discharge outlet, said second pump system adapted to discharge the contents of said clear well interior out through said discharge outlet.

2. A wastewater treatment system as recited in claim 1, further comprising:
a bioreactor vent pipe outletting the bioreactor interior above a ground surface to an ambient atmosphere.

3. A wastewater treatment system as recited in claim 2, further comprising:
an air pipe inserted through the bioreactor top, through the bioreactor interior, through the filter media and gravel bed, said air pipe being interconnected to an aeration assembly on the ground surface, said air pipe adapted to providing aeration of the sand filter, said aeration assembly having a plurality of backwash blowers and a plurality of process blowers.

4. A wastewater treatment system as recited in claim 3, further comprising:
an outlet backwash line inserted through the bioreactor side wall above the filter media, said backwash line interconnected to a system headworks at the equalization influent inlet.

5. A wastewater treatment system as recited in claim 4, wherein:
the equalization tank outlet is positioned vertically lower than the equalization tank inlet; and
the clear well first inlet is positioned vertically lower than the equalization tank outlet.

6. A wastewater treatment system as recited in claim 5, wherein:
said first pump system is adapted to pump a liquid from the clear well interior back up through the clear well first inlet, clear well inlet pipe, into the bioreactor interior, through the gravel bed and sand filter, wherein said reverse flow fills a bioreactor head space in the bioreactor interior above the filter media, wherein said liquid in said filled bioreactor head space flows back through the sand filter into said clear well.

7. A wastewater treatment system as recited in claim 6, further comprising:
a plurality of aeration diffusers in the clear well interior adjacent the clear well bottom; and
a process air interconnected to the air pipe and connected to said aeration diffusers.

8. A wastewater treatment system as recited in claim 7, further comprising:
a plurality of remotely controlled electrically activated valves in said air pipe and process air pipe, said valves adapted to control air flow through the air pipe and process air pipe.

9. A wastewater treatment system as recited in claim 8, wherein:
said gravel bed is positioned on the underdrain and said filter media positioned on the gravel bed.

10. A wastewater treatment system as recited in claim 9, wherein:
the filter media is comprised of a bed of coarse round, silica sand.

11. A wastewater treatment system as recited in claim 10, wherein:
said silica sand has a diameter in the range of 2.5-3.5 millimeters.

12. A wastewater treatment system as recited in claim 11, further comprising:
a check valve in said equalization tank outlet, said valve adapted to prevent a reverse flow from the bioreactor into the equalization tank.

13. A wastewater treatment system as recited in claim 6, further comprising:
a membrane microfiltration unit attached to the clear well discharge outlet.

14. A wastewater treatment system as recited in claim 8, further comprising:
a membrane microfiltration unit attached to the clear well discharge outlet.
